(19) United States
(12) Patent Application Publication
(10) Pub. No.: US 2026/0103220 A1
(43) Pub. Date: Apr. 16, 2026

(54) Method of Controlling Autonomous Vehicle and Vehicle Therefor

(71) Applicants: Hyundai Motor Company, Seoul (KR); Kia Corporation, Seoul (KR)

(72) Inventors: Jeong Woo Kim, Hwaseong-Si (KR); Sung Yoon Yeo, Hwaseong-Si (KR); Seung Joon Lee, Hwaseong-Si (KR); Su Jung Yoo, Hwaseong-Si (KR); Beom Jun Kim, Hwaseong-Si (KR)

(21) Appl. No.: 19/226,520

(22) Filed: Jun. 3, 2025

(30) Foreign Application Priority Data
Jul. 17, 2024 (KR) 10-2024-0094128

(51) Int. Cl. B60W 60/00; B60W 30/14

(52) U.S. Cl. CPC B60W 60/0015; B60W 30/143; B60W 60/0053; B60W 60/0059; B60W 2552/00; B60W 2554/4042; B60W 2554/4046; B60W 2554/406; B60W 2554/80; B60W 2555/60

(57) ABSTRACT

A method for controlling autonomous driving of a vehicle is introduced. The method may comprise determining whether a side lane is in a traffic congestion situation based on road information associated with the side lane, object information associated with the side lane, and vehicle information associated with the vehicle, wherein the side lane is within a threshold distance from a driving lane of the vehicle. The method also may comprise generating congestion control information based on the road information, the object information, and a determination that the side lane is in the traffic congestion situation, wherein the congestion control information is related to a longitudinal control of the vehicle. The method may comprise generating operation-based longitudinal control information based on a plurality of speeds, wherein each speed is respectively derived from the congestion control information, the road information, the object information, and the vehicle information, and controlling autonomous driving.

### CROSS-REFERENCE TO RELATED APPLICATION

This application claims the benefit of priority to Korean Patent Application No. 10-2024-0094128, filed in the Korean Intellectual Property Office on Jul. 17, 2024, the disclosure of which is incorporated herein by reference in its entirety.

### FIELD

The present disclosure relates to a method of controlling an autonomous vehicle and a vehicle, and more specifically, to a method of controlling an autonomous vehicle adaptive to traffic situations that improves driving performance by supporting an autonomous driving plan specialized for traffic congestion situations to prevent discomfort caused to a user, and a vehicle.

### BACKGROUND

The matters described in this Background section are only for the enhancement of understanding of the background of the disclosure, and should not be taken as acknowledgment that they correspond to prior art already known to those skilled in the art.

Vehicles equipped with autonomous driving functions tend to be commercialized for driving convenience. Autonomous driving functions are being developed so that fully autonomous driving in which a vehicle takes full driving control without driver intervention in any situation becomes a reality. Some functions of fully autonomous driving are being installed and utilized in commercial vehicles.

An autonomous driving-based vehicle may recognize the surrounding environment obtained by sensors, and in addition, may acquire various data from inside and outside the vehicle, identify a situation around the vehicle based on the recognized surrounding environment and data, establish an autonomous driving strategy or control plan corresponding to the identified situation, and control actuators of the vehicle to drive according to the strategy.

Autonomous driving strategy may provide a simple level plan such as evasive driving depending on the surrounding environment and data, but may use detailed plans tailored to different situations to provide advanced levels of driving control to suit various situations.

For example, in order to autonomously drive at an optimal speed while maintaining a safe distance from a preceding vehicle and surrounding vehicles, the vehicle may have a built-in control logic for establishing a speed and route of a host vehicle based on a relative speed of the host vehicle with respect to the speed of the preceding vehicle or surrounding vehicles, relative longitudinal and lateral distances between the vehicles, and the like. The control logic is commonly applied regardless of road traffic congestion. The road traffic congestion may be caused by an excessive number of vehicles, or may be caused by a cut-in where surrounding vehicles enter a target vehicle's lane, or the like. Even though the distance between vehicles may not increase due to road traffic congestion, the autonomous driving control plan may not recognize a traffic congestion section, and may control the vehicle by either excessive speed increase due to detours simply to maintain the distance from the surrounding vehicles or significant speed decrease due to passive driving. The aforementioned control may cause discomfort to users in traffic congestion sections, which may act as a factor of reducing ride comfort and driving performance.

In order to alleviate the discomfort caused by autonomous driving in a traffic congestion section, accurate determination of the traffic congestion section, identification of detailed situations in the traffic congestion section, and various autonomous control methods in the traffic congestion section suitable for the detailed situations are being attempted.

### SUMMARY

The present disclosure is directed to providing a method of controlling an autonomous vehicle that improves driving performance by supporting an autonomous driving plan specialized for traffic congestion situations to prevent discomfort caused to a user, and a vehicle.

According to the present disclosure, a method performed by an apparatus for controlling autonomous driving of a vehicle, the method may comprise determining whether a side lane is in a traffic congestion situation based on road information associated with the side lane, object information associated with the side lane, and vehicle information associated with the vehicle, wherein the side lane is within a threshold distance from a driving lane of the vehicle, generating congestion control information based on the road information, the object information, and a determination that the side lane is in the traffic congestion situation, wherein the congestion control information is related to a longitudinal control of the vehicle, generating operation-based longitudinal control information based on a plurality of speeds, wherein each speed of the plurality of speeds is respectively derived from the congestion control information, the road information, the object information, and the vehicle information, and controlling, based on at least the operation-based longitudinal control information, autonomous driving of the vehicle.

The method, wherein the road information may comprise lane level route information related to the driving lane of the vehicle and the side lane, road restriction information related to a speed limit of a road, road structure information related to a structure of the road, and road event information related to an event in a driving area, wherein the object information may comprise data related to a behavior of a dynamic object within a threshold spatial range of the vehicle, and wherein the vehicle information may comprise a longitudinal state of the vehicle, a sensor detection range of an environment associated with the vehicle, and data related to autonomous driving control.

The method, wherein the determining whether the side lane is in the traffic congestion situation may comprise determining whether the side lane is in the traffic congestion situation based on the lane level route information, the road restriction information, the longitudinal state of the vehicle, and the behavior of the dynamic object, wherein the dynamic object may comprise another vehicle moving in the side lane.

The method, wherein the generating the operation-based longitudinal control information may comprise identifying a plurality of individual target speeds, wherein each individual target speed of the plurality of individual target speeds is respectively derived from the road restriction information, the road event information, the sensor detection range of the vehicle, the behavior of the dynamic object, and the congestion control information, wherein the dynamic object may comprise a pedestrian, and generating, based on a minimum individual target speed among the plurality of individual target speeds, the operation-based longitudinal control information.

The method, wherein the determining whether the side lane is in the traffic congestion situation may comprise determining whether a number of identified vehicles traveling in the side lane, identified based on the object information, is greater than or equal to a first value corresponding to an existence condition, wherein the side lane is within a predetermined range of the vehicle, based on the number of identified vehicles traveling in the side lane being greater than or equal to the first value, determining whether a number of identified vehicles that satisfy an agent condition is greater than or equal to a second value, wherein the agent condition is related to a driving motion, a position, and a speed derived from the object information, and wherein the objection information may comprise information about identified vehicles that satisfy the existence condition, based on the number of identified vehicles that satisfy the agent condition being greater than or equal to the second value, determining whether a number of agent sets that satisfy both the agent condition and a distance condition of the identified vehicles is greater than or equal to a third value, and based on the number of the agent sets being greater than or equal to the third value, determining that the side lane is in the traffic congestion situation.

The method may further comprise, after the controlling the autonomous driving of the vehicle, determining whether a number of identified vehicles traveling in the side lane, identified based on the object information, is less than a fourth value corresponding to a release condition, wherein the side lane is within a predetermined range of the vehicle, based on the number of identified vehicles traveling in the side lane being less than the fourth value, determining whether a number of identified vehicles that satisfy an agent requirement condition is less than a fifth value, wherein the agent requirement condition is related to a position and speed derived from the object information, and wherein the object information may comprise information about identified vehicles that satisfy the release condition, and based on the number of identified vehicles that satisfy the agent requirement condition being less than the fifth value, determining a release of the traffic congestion situation.

The method may further comprise, before the controlling the autonomous driving of the vehicle, generating additional longitudinal control information, wherein the additional longitudinal control information may comprise at least one of longitudinal control information based on a front object traveling in the driving lane, surrounding state-based longitudinal control information according to a driving motion of an identified vehicle traveling in the side lane and a road shape, and autonomous driving risk reduction-based longitudinal control information defined in an action plan related to control transfer from autonomous driving to manual driving, and generating, based on the operation-based longitudinal control information and the additional longitudinal control information, final longitudinal control information, wherein the controlling the autonomous driving of the vehicle may comprise controlling, based on the final longitudinal control information, the autonomous driving of the vehicle.

The method, wherein the generating the congestion control information may comprise determining a traffic congestion section speed, wherein the traffic congestion section speed is determined based on a weighted sum of a speed limit required for the vehicle in the driving lane, and an average traffic congestion speed of identified vehicles traveling in the side lane, determining the traffic congestion section speed as a traffic congestion target speed based on the traffic congestion section speed being greater than a minimum traffic congestion control speed, and determining the minimum traffic congestion control speed as the traffic congestion target speed based on the traffic congestion section speed being equal to or lower than the minimum traffic congestion control speed.

The method, wherein the weighted sum may comprise a first weight applied to the average traffic congestion speed, and a second weight applied to the speed limit, and wherein the first weight is greater than the second weight.

The method may further comprise based on absence of the traffic congestion situation, generating second operation-based longitudinal control information based on a plurality of speeds, wherein each speed of the plurality of speeds is respectively derived from the road information, the object information, and the vehicle information, and controlling, based on at least the second operation-based longitudinal control information, the autonomous driving of the vehicle.

According to the present disclosure, an apparatus for controlling autonomous driving of a vehicle, the apparatus may comprise a sensor configured to detect an environment within a threshold range of the vehicle, a processor configured to execute at least one instruction, and a memory configured to store the at least one instruction that, when executed by the processor, is configured to cause the apparatus to determine whether a side lane is in a traffic congestion situation based on road information associated with the side lane, object information associated with the side lane, and vehicle information associated with the vehicle, wherein the side lane is within a threshold distance from a driving lane of the vehicle, generate congestion control information based on the road information, the object information, and a determination that the side lane is in the traffic congestion situation, wherein the congestion control information is related to a longitudinal control of the vehicle, generate operation-based longitudinal control information based on a plurality of speeds, wherein each speed of the plurality of speeds is respectively derived from the congestion control information, the road information, the object information, and the vehicle information, and control, based on at least the operation-based longitudinal control information, autonomous driving of the vehicle.

The apparatus, wherein the road information may comprise lane level route information related to the driving lane of the vehicle and the side lane, road restriction information related to a speed limit of a road, road structure information related to a structure of the road, and road event information related to an event in a driving area, wherein the object information may comprise data related to a behavior of a dynamic object within a threshold spatial range of the vehicle, and wherein the vehicle information may comprise a longitudinal state of the vehicle, a sensor detection range of the sensor, and data related to autonomous driving control.

The apparatus, wherein the at least one instruction, when executed by the processor, is configured to cause the apparatus to determine whether the side lane is in the traffic congestion situation by determining whether the side lane is in the traffic congestion situation based on the lane level route information, the road restriction information, the longitudinal state of the vehicle, and the behavior of the dynamic object, wherein the dynamic object may comprise another vehicle moving in the side lane.

The apparatus, wherein the at least one instruction, when executed by the processor, is configured to cause the apparatus to generate the operation-based longitudinal control information by identifying a plurality of individual target speeds, wherein each individual target speed of the plurality of individual target speeds is respectively derived from the road restriction information, the road event information, the sensor detection range of the sensor, the behavior of the dynamic object, and the congestion control information, wherein the dynamic object may comprise a pedestrian, and generating, based on a minimum individual target speed among the plurality of individual target speeds, the operation-based longitudinal control information.

The apparatus, wherein the at least one instruction, when executed by the processor, is configured to cause the apparatus to determine whether the side lane is in the traffic congestion situation by determining whether a number of identified vehicles traveling in the side lane, identified based on the object information, is greater than or equal to a first value corresponding to an existence condition, wherein the side lane is within a predetermined range of the vehicle, based on the number of identified vehicles traveling in the side lane being greater than or equal to the first value, determining whether a number of identified vehicles that satisfy an agent condition is greater than or equal to a second value, wherein the agent condition is related to a driving motion, a position and a speed derived from the object information, and wherein the object information may comprise information about surrounding vehicles that satisfy the existence condition, based on the number of identified vehicles that satisfy the agent condition being greater than or equal to the second value, determining whether a number of agent sets that satisfy both the agent condition and a distance condition of the identified vehicles is greater than or equal to a third value, and based on the number of the agent sets being greater than or equal to the third value, determining that the side lane is in the traffic congestion situation.

The apparatus, wherein after controlling the autonomous driving of the vehicle, the at least one instruction, when executed by the processor, is further configured to cause the apparatus to determine whether a number of identified vehicles traveling in the side lane, identified based on the object information, is less than a fourth value corresponding to a release condition, wherein the side lane is within a predetermined range of the vehicle, based on the number of identified vehicles traveling in the side lane being less than the fourth value, determine whether a number of identified vehicles that satisfy an agent requirement condition is less than a fifth value, wherein the agent requirement condition is related to a position and speed derived from the object information, and wherein the object information may comprise information about identified vehicles that satisfy the release condition, and based on the number of identified vehicles that satisfy the agent requirement condition being less than the fifth value, determine a release of the traffic congestion situation.

The apparatus, wherein before the controlling the autonomous driving of the vehicle, the at least one instruction, when executed by the processor, is further configured to cause the apparatus to generate additional longitudinal control information, wherein the additional longitudinal control information may comprise at least one of longitudinal control information based on a front object traveling in the driving lane, surrounding state-based longitudinal control information according to a driving motion of an identified vehicle traveling in the side lane and a road shape, and autonomous driving risk reduction-based longitudinal control information defined in an action plan related to control transfer from autonomous driving to manual driving, generate, based on the operation-based longitudinal control information and the additional longitudinal control information, final longitudinal control information, and control the autonomous driving of the vehicle by controlling, based on the final longitudinal control information, the autonomous driving of the vehicle.

The apparatus, wherein at least one instruction, when executed by the processor, is configured to cause the apparatus to generate the congestion control information by determining a traffic congestion section speed, wherein the traffic congestion section speed is determined based on a weighted sum of a speed limit required for the vehicle in the driving lane of the vehicle, and an average traffic congestion speed of identified vehicles traveling in the side lane, determining the traffic congestion section speed as a traffic congestion target speed based on the traffic congestion section speed being greater than a minimum traffic congestion control speed, and determining the minimum traffic congestion control speed as the traffic congestion target speed based on the traffic congestion section speed being equal to or lower than the minimum traffic congestion control speed.

The apparatus, wherein the weighted sum may comprise a first weight applied to the average traffic congestion speed, and a second weight applied to the speed limit, and wherein the first weight is greater than the second weight.

The apparatus, wherein the at least one instruction, when executed by the processor, is further configured to cause the apparatus to, based on absence of the traffic congestion situation, generate second operation-based longitudinal control information based on a plurality of speeds, wherein each speed of the plurality of speeds is respectively derived from the road information, the object information, and the vehicle information, and control, based on at least the second operation-based longitudinal control information, the autonomous driving of the vehicle.

Technical problems to be solved in the present disclosure are not limited to the technical problems, which have been mentioned above, and other technical problems that are not mentioned will be clearly understood by those of ordinary skill in the art to which the present disclosure belongs from the following description.

### BRIEF DESCRIPTION OF THE DRAWINGS

The above and other objects, features and advantages of the present disclosure will become more apparent to those of ordinary skill in the art by describing examples thereof in detail with reference to the accompanying drawings, in which:

FIG. 1 shows an example of a vehicle transmitting and receiving data by communicating with another device;

FIG. 2 shows an example of modules constituting a vehicle according to one example of the present disclosure;

FIG. 3 shows an example of a logic of a processor related to determining a traffic congestion situation and generating longitudinal control information according to the traffic congestion situation;

FIG. 4 shows an example of a method of controlling a vehicle according to another example of the present disclosure;

FIG. 5 shows an example of a form of a road on which a vehicle travels and surrounding vehicles;

FIG. 6 shows an example of a process of determining entry into a traffic congestion situation; and

FIG. 7 shows an example of a process of determining release of a traffic congestion situation.

### DETAILED DESCRIPTION

Hereinafter, examples of the present disclosure will be described in detail with reference to the accompanying drawings so that those skilled in the art may easily implement the present disclosure. However, the present disclosure may be implemented in various different ways, and is not limited to the examples described therein.

In describing examples of the present disclosure, well-known functions or constructions will not be described in detail since they may unnecessarily obscure the understanding of the present disclosure. The same constituent elements in the drawings are denoted by the same reference numerals, and a repeated description of the same elements will be omitted.

In the present disclosure, when an element is simply referred to as being “connected to”, “coupled to” or “linked to” another element, this may mean that an element is “directly connected to”, “directly coupled to” or “directly linked to” another element or is connected to, coupled to or linked to another element with the other element intervening therebetween. In addition, when an element “includes” or “has” another element, this means that one element may further include another element without excluding another component unless specifically stated otherwise.

In the present disclosure, the terms first, second, etc. are only used to distinguish one element from another and do not limit the order or the degree of importance between the elements unless specifically mentioned. Accordingly, a first element in an example could be termed a second element in another example, and, similarly, a second element in an example could be termed a first element in another example, without departing from the scope of the present disclosure.

In the present disclosure, elements that are distinguished from each other are for clearly describing each feature, and do not necessarily mean that the elements are separated. That is, a plurality of elements may be integrated in one hardware or software unit, or one element may be distributed and formed in a plurality of hardware or software units. Therefore, even if not mentioned otherwise, such integrated or distributed examples are included in the scope of the present disclosure.

In the present disclosure, elements described in various examples do not necessarily mean essential elements, and some of them may be optional elements. Therefore, an example composed of a subset of elements described in an example is also included in the scope of the present disclosure. In addition, examples including other elements in addition to the elements described in the various examples are also included in the scope of the present disclosure.

The advantages and features of the present disclosure and the way of attaining them will become apparent with reference to examples described below in detail in conjunction with the accompanying drawings. Examples, however, may be embodied in many different forms and should not be constructed as being limited to example examples set forth herein. Rather, these examples are provided so that this disclosure will be complete and will fully convey the scope of the disclosure to those skilled in the art.

In the present disclosure, each of phrases such as “A or B”, “at least one of A and B”, “at least one of A or B”, “A, B or C”, “at least one of A, B and C”, “ ” at Each of the phrases such as “at least one of A, B or C” and “at least one of A, B, C or combination thereof” may include any one or all possible combinations of the items listed together in the corresponding one of the phrases.

Hereinafter, examples of the present disclosure will be described with reference to the accompanying drawings.

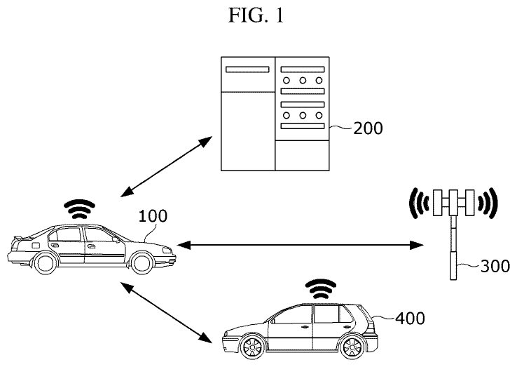

Referring to FIGS. 1 to 3, a vehicle adaptively controlled based on traffic conditions will be described. FIG. 1 shows an example of a vehicle transmitting and receiving data by communicating with another device;

Referring to FIG. 1, the vehicle 100 may be driven based on electric energy or fossil energy. In the case of electric energy, the vehicle 100 may adopt a pure battery-based vehicle driven solely by a high-voltage battery or a gas-based fuel cell as an energy source. The fuel cell may utilize various types of gases capable of generating electric energy, and the gas may be filled in the vehicle 100 in a liquefied state. For instance, the gas may be hydrogen, but various other gases may also be applicable. In the case of fossil energy, the vehicle 100 may be driven based on fuels such as gasoline, diesel, or liquefied gas, and it may be equipped with an internal combustion engine that drives an actuator 116 by burning the fuel. The engine may be included in an energy generator 110 in terms of providing rotational driving force to the wheel driver 118. As another example, the vehicle 100 may be a hybrid type vehicle selectively utilizing the energy of a fossil fuel-based internal combustion engine and an electric battery to drive the actuating unit 116.

The vehicle 100 may refer to a movable device. The vehicle 100 may be a ground vehicle, such as a typical passenger or commercial vehicle, or a purpose-built vehicle (PBV) for specific purposes. The vehicle 100 may be a four-wheeled vehicle, such as a passenger car, SUV, or small truck, or a vehicle with more than four wheels, such as a bus, large truck, container carrier, or heavy equipment. The vehicle 100 may also be a robot in the broad sense of a movable means, and the robot may move using wheels, tracks, or other mobility modules.

The vehicle 100 may be controlled and driven autonomously, and autonomous driving may be implemented as semi-autonomous driving or fully autonomous driving. Fully autonomous driving may be provided as autonomous movement in which the processor 122 of the vehicle 100 fully controls the driving without user intervention, even in uncertain driving conditions. Semi-autonomous driving may be provided as autonomous movement that requires driver intervention in specific driving situations. Semi-autonomous driving may be implemented to enable manual driving by transferring control to the user when the processor 122 deactivates autonomous driving upon occurrence of such situations. According to the autonomous driving levels defined by the Society of Automotive Engineers (SAE), semi-autonomous driving may correspond to levels 1 to 4, and fully autonomous driving may correspond to level 5.

Specifically, an automation level of an autonomous driving vehicle may be classified as follows, according to SAE. At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., features of longitudinal control information) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., features of longitudinal control information) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., features of longitudinal control information) described herein.

Minimum risk maneuver (MRM) operation(s) may also be controlled, for example, based on one or more features (e.g., features of longitudinal control information) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., features of longitudinal control information) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., features of longitudinal control information) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.),

Meanwhile, the vehicle 100 may perform communication with other devices 200, 300, or other vehicles 400. The other devices may include, for example, a server 200 supporting various control state management and driving of the vehicle 100, an Intelligent Transportation System (ITS) device 300 for receiving information from ITS, and various types of user devices. The server 200 may be an external device operated by a vehicle manufacturer or prepared to provide autonomous driving services and may transmit or receive connected data necessary for autonomous driving to or from the vehicle 100. The server 200 may transmit various information and software modules used for the control of the vehicle 100 in response to requests and data transmitted from the vehicle 100 and user devices to support autonomous driving and various services of the vehicle 100.

The ITS device 300, for instance, may be a Road Side Unit (RSU). The ITS device 300 may exchange vehicle perception data, driving control and state data, environmental data around the vehicle, and map data with the vehicle 100 through Vehicle-to-Infrastructure (V2I) communication to assist the user's driving or support autonomous driving of the vehicle 100. The vehicle 100 may support manual or autonomous driving by exchanging the aforementioned data with other vehicles 400 through Vehicle-to-Vehicle (V2V) communication.

The vehicle 100 may perform communication with other vehicles or devices based on cellular communication, Wireless Access in Vehicular Environment (WAVE) communication, Dedicated Short Range Communication (DSRC), or other communication methods. For instance, the vehicle 100 may use communication networks such as LTE or 5G, WiFi networks, or WAVE networks for communication with the server 200, ITS device 300, and other vehicles 400. In another example, DSRC used in the vehicle 100 may be utilized for inter-vehicle communication. The communication methods among the vehicle 100, the server 200, the ITS device 300, other vehicles 400, and user devices are not limited to the above-described examples.

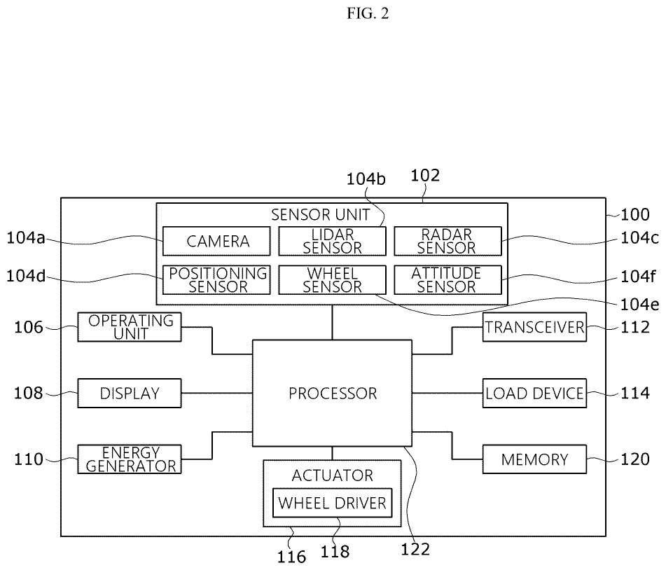

FIG. 2 shows an example of modules constituting a vehicle according to one example of the present disclosure;

The vehicle 100 may include a sensor unit 102, an operating unit 106, a display 108, a load device 114, and a transceiver 112.

The sensor unit 102 may be equipped with various types of detectors to sense various states and situations occurring in the external environment, internal system, user operations, and passenger space of the vehicle 100. Specifically, the sensor unit 102 may include external-facing cameras 104a, LIDAR sensors 104b, radar sensors 104c, and the like to recognize dynamic and static objects existing outside the vehicle 100. The camera 104a may recognize external objects as images during the use of the vehicle 100, generate image data, and transmit the image data to the processor 122. The LIDAR sensor 104b may generate point cloud data as recognized data of external objects to generate three-dimensional spatial information identifying the shape of at least the external objects and transmit the point cloud data to the processor 122. The radar sensor 104c may generate radar data by emitting radio waves of a specific frequency around the vehicle 100 and recognizing the external objects through the reflected radio waves to identify the presence, relative distance, speed, and direction of external objects. Although the present disclosure illustrates including the LIDAR sensor 104b, it may not be included in other examples.

The sensor unit 102 may include positioning sensor 104d, wheel sensor 104e, and attitude sensor 104f to confirm its position, speed, and driving posture. The attitude sensor 104f may include a gyro sensor, angular velocity sensor, accelerometer, and the like.

In the present disclosure, the sensor unit 102 includes sensors mainly referenced in the description of the examples but may further include sensors detecting various situations not listed herein.

The operating unit 106 may be configured as a module for user control for driving. For instance, the operating unit 106 may include a steering wheel for manual driving, an automatic or manual transmission actuator, an accelerator pedal, a brake pedal, a gearbox, etc. The operating unit 106 may further include an interface for the use/deactivation of the autonomous driving mode requested by the user and the selection of detailed function to utilize the autonomous driving function. The operating unit 106 may be configured as a hard-type interface provided at a predetermined position inside the vehicle 100 or a soft-type interface touchable on the display 108 to receive various requests related to autonomous driving.

The display 108 may function as a user interface. The display 108 may display the operation state, control state, route/traffic information, remaining energy information, and contents requested by the driver of the vehicle 100 as controlled by the processor 122. The display 108 may also receive driver's requests instructing the processor 122 by being configured as a touch screen detecting driver input.

The load device 114 may be mounted on the vehicle 100 and be a kind of electric device for non-driving use, excluding the driving power system such as the wheel driver 118. The load device 114 may be an auxiliary device supplied with power from the energy generator 110, such as an air conditioning system, lighting system, seat system, and various devices installed in the vehicle 100.

The transceiver 112 may support mutual communication with the server 200, ITS device 300, and surrounding vehicles 300. The transceiver 112 may include modules handling cellular communication, WAVE, DSRC communication, etc. For instance, the transceiver 116 may transmit data generated or stored during driving to the server 200 and receive data and software modules transmitted from the server 200. The transceiver 116 may also support communication with electronic devices carried by passengers inside the vehicle 100. In the present disclosure, the vehicle 100 may transmit and receive data utilized in the methods according to the present disclosure through the transceiver 116.

The vehicle 100 may also include an energy generator 114 and an actuating unit 116.

The energy generator 110 may generate and supply power and electricity used in the driving power system, such as the actuating unit 118, and the non-driving power system. The non-driving power system may include, for example, the sensor unit 102, operating unit 106, display 108, load device 114, transceiver 112, and the like, and may include various components implementing sensing, interface, communication, and convenience functions, excluding components directly involved in driving operations. When the vehicle 100 is driven based on electric energy, the energy generator 110 may be configured as an electric battery charged from an external source or a combination of an electric battery and a fuel cell charging the battery. In the case of a combination of an electric battery and a fuel cell, the energy generator 110 may include a tank storing a material, such as liquefied hydrogen, used to generate power in the fuel cell. When the vehicle 100 is driven based on fossil energy, the energy generator 110 may be configured as an internal combustion engine. Additionally, when the vehicle 100 is of a hybrid type, the energy generator 110 may be provided as a combination of an internal combustion engine and an electric battery.

The actuator 116 may include at least one module implementing driving operations and may perform at least one of longitudinal control, such as acceleration and deceleration, and lateral control, such as steering, based on user requests from the operating unit 106. The actuator 116 may include mechanical components and electronic modules implementing driving operations in the wheel driver 118 to perform driving operations according to commands of the processor 122 for manual control or autonomous driving. When the vehicle 100 is operated based on electric energy, it may include an assembly for delivering the requested driving operations to the wheel driver 118. When the vehicle 100 is operated based on fossil energy, the actuator 116 may include a transmission gear module delivering the power of the internal combustion engine.

The wheel driver 118 may include a driving force generating module generating driving force for multiple wheels or transferring driving force to the wheels, a braking module decelerating the driving of the wheels, and a steering module realizing lateral control of the wheels. When the vehicle 100 is driven based on electric energy, the driving force generating module may be configured as a motor assembly generating driving force based on the power output from the electric battery. The braking module of the electric-based vehicle 100 may further have a regenerative braking function.

In addition or alternative, the vehicle 100 may include a memory 120 and a processor 122.

The memory 120 may store applications and various data for controlling the vehicle 100, and load applications or read and record data by a request of the processor 122. In the present disclosure, the memory 120 may store an application and at least one instruction for determining a traffic congestion situation for a driving area of the autonomous vehicle 100 and generating congestion control information based on the traffic congestion situation. In addition or alternative, the memory 120 may generate final longitudinal control information based on various data including congestion control information and hold applications and instructions for controlling the vehicle 100 in the traffic congestion situation according to the information. For example, the congestion control information may comprise data such as target speeds, speed profiles, lane-specific adjustments, and event-specific speeds for scenarios like merging or curved sections. This information may help optimize the vehicle's longitudinal control for safe and smooth driving in a traffic congestion situation.

The longitudinal control may be control related to a speed, an acceleration, and a relative distance to a surrounding vehicle of the vehicle 100. As one example, the longitudinal control may be motion control in autonomous driving. As another example, the longitudinal control may be used in manual driving as well as autonomous driving. When there is a manual operation that is different from an operation appropriate for the surrounding situation, the processor 122 may intervene in manual driving with the longitudinal control that matches the surrounding situation, or may provide longitudinal control-related data to a manual driver.

Accordingly, as one example, the longitudinal control information may include a speed and an acceleration applied to the vehicle 100. The speed and the acceleration may be generated as longitudinal data that applies to any one of a time range, a distance range, or a specific section along a route. The longitudinal control information may be described as profiles of continuous velocity and acceleration over the range or section. As another example, in addition or alternative to the speed and the acceleration, the longitudinal control information may further include control factors applied to the vehicle 100, for example, control according to a relative required distance to surrounding vehicles.

The memory 120 may manage road information, surrounding object information, and vehicle information to generate final longitudinal control information depending on the presence or absence of the traffic congestion situation. For example, the surrounding object information may comprise details about the type, position, speed, proximity, and behavior of nearby objects, such as vehicles or other dynamic entities. This information, detected through sensors like cameras or radar, may help the vehicle evaluate traffic conditions and adjust the vehicle's control strategies.

The road information may include lane level route information, road restriction information, a road structure, a traffic sign information, and road event information related to the driving lane in which the vehicle 100 moves and surrounding lanes. In the present disclosure, the road on which the vehicle 100 moves may have a plurality of lanes, and may specifically include a driving lane on which the vehicle 100 travels and surrounding lanes near the driving lane. The lane level route information may be obtained from lane images or map information acquired from, for example, the camera 104a. The map information is, for example, a lane-level precision map, and may be obtained from an external device such as the server 200 and managed in the memory 120. The lane level route information may include a trajectory (or route) of each lane, its width, parameters applied to functions related to each lane, and the like. The road restriction information may be a speed limit required on the road on which the vehicle 100 is traveling and a vehicle behavior required to comply with regulations related to the corresponding road. The traffic sign information may be information related to traffic control and guidance displayed on a road surface and signs installed on the road. The traffic sign information may include, for example, crosswalks, stop lines, U-turns, left turns, speed limits, milestones, and the like.

The road structure may be related to a road shape. The road structure may include information representing, for example, the number of lanes, a road geometry such as a straight or curved line, a road merging section, a road branch section, a road gradient, a tunnel section, road three-dimensionality (e.g., a ground road and an elevated road), and the like. The road event information may be information related to an event on the road. The road event information may include, for example, a construction zone, road event information, and a slow-speed section due to bad weather.

The surrounding object information may include data related to the behavior of dynamic objects around the vehicle 100. The surrounding object information is behavior data derived by analyzing dynamic objects obtained from at least one of the sensor unit 102, the intelligence transportation system (ITS) device 300, and other vehicles 100 by the processor 122, and the behavior data may be managed in the memory 120. Dynamic objects may be, for example, surrounding vehicles, pedestrians, or other types of mobility, and other types of mobility may be personal mobility such as bicycles or electric scooters. The behavior of the dynamic object may include information related to the position, speed, motion, or the like, of the dynamic object. The speed may include, for example, the speed of each surrounding vehicle and the average speed of surrounding vehicles in a predetermined area. The motion may be defined based on a movement pattern of the dynamic object. Taking a vehicle as an example, the motion may be referred to as a driving motion of the vehicle, and the driving motion may be divided into lane keeping driving and biased driving. The lane keeping driving may be a motion in which surrounding vehicles substantially travel along center areas of their own lanes without deviating from the lanes, thereby causing no interference with the driving of the host vehicle traveling in the adjacent lane. The bias driving may be a motion in which a surrounding vehicle does not deviate from its own lane, but travels eccentrically from the center area and approaches the driving lane used by the host vehicle or some of surrounding vehicles deviate from their own lanes and enter the lane of the host vehicle, thereby causing interference with the driving of the host vehicle.

The vehicle information may refer to information related to the vehicle according to an example of the present disclosure. The vehicle information may include data related to a longitudinal state of the vehicle 100, a sensing detection range of the surrounding environment of the sensor unit 102 mounted on the vehicle 100, and autonomous driving control. The longitudinal state may include a driving lane, a position, a speed, an acceleration, and a distance to a surrounding vehicle of the vehicle 100, and may be acquired by the camera 104a, the positioning sensor 104d, the wheel sensor 104e, the attitude sensor 104f, the radar sensor 104c, and the like, and managed in the memory 120. The sensing detection range may be a distance and an area detected by the detection performance of the sensor unit 102 that varies depending on the road shape, weather, or the like. The road shape and weather may be confirmed by road information, surrounding situations detected by the sensor unit 102, and external information provided by the server 200 or the like. Specifically, the detection range of the camera 104a, the lidar sensor 104b, and the radar sensor 104c varies depending on a gradient of a front road and the weather, and the variable detection range may be managed in the memory 120 as the sensing detection range. As another example, the detection range according to the gradient and weather may be stored in the memory 120 in a pre-tabulated form.

The data related to autonomous driving control may include a control plan according to various driving situations of the vehicle 100. Here, the driving situation may be, for example, evasive driving, following a preceding vehicle, changing lanes, driving at an intersection, or the like. In the present disclosure, the data may be described mainly in terms of a control plan (or an action plan) related to control transfer from autonomous driving to manual driving among various driving situations, but is not limited thereto. The action plan may be a plan to reduce instability due to the control transfer, that is, the risk of autonomous driving. When a driving situation that the processor 122 cannot handle occurs, the action plan related to the control transfer may include, for example, a control to notify a user of the transfer in advance and move the vehicle 100 to a safe area on the road at a specific speed and stop the vehicle 100 when the user does not operate the vehicle 100 for a specified period of time after the notification. The transfer-related action plan is not limited to the above-described examples and may be established using various methods and speeds.

The map information stored in the memory 120 may be used to generate a driving route set in the vehicle 100 by the request of the user or the processor 122. In addition or alternative, the map information is utilized for autonomous driving, and may include a low-precision map or include a high-precision map together with the map. The map information may be provided to have various information and data included in driving environment information.

The processor 122 may perform overall control of the vehicle 100. The processor 122 may be configured to execute applications and instructions stored in the memory 120.

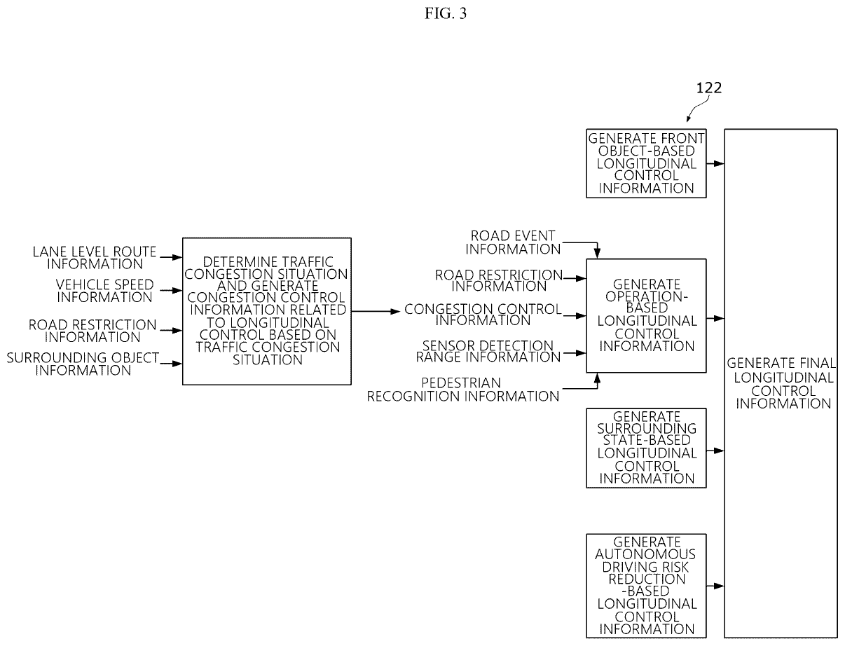

FIG. 3 shows an example of a logic of a processor related to determining a traffic congestion situation and generating longitudinal control information according to the traffic congestion situation.

The processor 122 may perform processing for determining whether a side lane around a driving lane of the vehicle 100 is in a traffic congestion situation based on road information in the side lane, surrounding object information in the side lane, and vehicle information using applications, instructions, and data stored in the memory 120.

In the present disclosure, the road on which the vehicle 100 moves may have a plurality of lanes, and specifically, may include at least a driving lane and a side lane based on a lane on which the vehicle 100 travels. In addition or alternative, the road may further include at least one additional lane on one side of the side lane.

The side lane may be a lane around the driving lane used by the host vehicle 100 or a target vehicle. The side lane has the same driving direction as the host vehicle 100, and may include surrounding lanes existing in front of and behind a current position of the host vehicle 100. Here, the front side lane may include a side lane arranged substantially parallel to the host vehicle 100. The side lane may be a lane directly adjacent to the driving lane of the host vehicle 100. The adjacent lane may include a parallel lane arranged in the same form as the driving lane and a merging lane that converges into the driving lane from either the front or rear of the host vehicle 100. In addition or alternative, the side lane may include a lane separated from the driving lane depending on the road structure. For example, if the road structure is a merging lane that converges into an adjacent lane in front of or behind the host vehicle 100, the merging lane may be considered as the side lane even though the merging lane is not directly adjacent to the driving lane.

In the present disclosure, the target for checking the traffic congestion situation is the side lane, but the target for applying longitudinal control depending on whether the traffic congestion situation occurs in the side lane may be the vehicle 100 in a driving area. Here, as one example, the driving area may be the driving lane of the host vehicle 100. As another example, the driving area may include a current driving lane and a future driving lane specified by a route of the autonomous driving. Driving of the host vehicle 100 in the driving lane may be impeded due to crowding or behavior (e.g., frequent cut-ins) of surrounding vehicles in the side lane and/or the driving lane. That is, if the driving of the host vehicle 100 is impeded or may be impeded due to the above-described matters, it may be recognized that the traffic congestion situation exists.

As shown in FIG. 3, the road information used to determine the traffic congestion situation may include at least lane level route information and road restriction information related to the driving lane and the side lane of the vehicle 100. The road restriction information may be, for example, a speed limit required on the road. The surrounding object information may include the behavior of surrounding vehicles moving in the side lane, for example, the position, speed, and motion of the surrounding vehicles. The vehicle information includes the longitudinal state of the host vehicle 100, and may include, for example, vehicle speed information, a driving lane, a position, an acceleration, and a distance to a surrounding vehicle of the vehicle 100.

A detailed process for determining the traffic congestion situation based on the information described above will be described below.

The processor 122 may perform processing for generating congestion control information related to the longitudinal control of the vehicle 100 based on the road information and the surrounding object information in response to the traffic congestion situation. The congestion control information may be a target speed of the vehicle 100 in the traffic congestion situation during the longitudinal control, but is not limited thereto, and may further include an acceleration and a distance to a surrounding vehicle. Referring to FIG. 3, the generation of the congestion control information may be executed in the same module as the module that determines the traffic congestion situation, but is not limited thereto. The road information used to generate the congestion control information may be a speed limit required on the road on which the vehicle is traveling. The surrounding object information may be, for example, an average speed of surrounding vehicles traveling in the side lane. A detailed process for generating the congestion control information based on the aforementioned information will be described below.

The processor 122 may execute processing for generating operation-based longitudinal control information using each speed from the congestion control information, the road information, the surrounding object information, and the vehicle information. The operation-based longitudinal control information may be a velocity/acceleration profile of the host vehicle 100. As another example, additional longitudinal information may include a relative distance to a surrounding vehicle that is required for the host vehicle 100, or the like, together with the profile.

As shown in FIG. 3, the road information may include road restriction information and road event information. The surrounding object information may have data related to the behavior of surrounding pedestrians belonging to dynamic objects, and may have, for example, a pedestrian recognition section according to a pedestrian behavior detected by the sensor unit 102. The vehicle information may be a sensing detection range of the sensor unit 102 that varies depending on the road shape, weather, or the like. A detailed process for generating longitudinal control information based on the above-described information will be described below.

In addition or alternative, the processor 122 may perform processing for generating additional longitudinal control information including at least one of front object-based longitudinal control information, surrounding state-based longitudinal control information, and autonomous driving risk reduction-based longitudinal control information. The additional longitudinal control information may have the same data as the operation-based longitudinal control information. Specifically, the additional longitudinal control information may be, for example, the velocity/acceleration profile of the host vehicle 100, and may include the relative distance to a surrounding vehicle, or the like, together with the profile.

The front object-based longitudinal control information may be the velocity/acceleration profile of the host vehicle 100 required by a front object traveling in the driving lane of the host vehicle 100, for example, a preceding vehicle. The front object-based longitudinal control information may be generated based on the surrounding object information and the road information related to the preceding vehicle in a driving lane EL.

The surrounding state-based longitudinal control information may be the velocity/acceleration profile of the host vehicle 100 according to the driving motion of the surrounding vehicles traveling in the side lane and the road shape. Specifically, the longitudinal control information may be generated based on the driving motion, the road structure, and the road event information about the surrounding vehicle traveling in the side lane. The driving motion may be, for example, biased driving or lane keeping. Examples of the road structure may include a curved shape, a merging section, a road branch section, a road gradient, a tunnel section, and the like.

The autonomous driving risk reduction-based longitudinal control information may be information defined in the action plan related to the control transfer from autonomous driving to manual driving. The longitudinal control information may be generated based on autonomous driving control-related data including the action plan of the vehicle corresponding to a user's non-operation in response to a request for the control transfer from autonomous driving to manual driving. The action plan is exemplified above, but is not limited thereto.

The processor 122 may generate the final longitudinal control information based on the operation-based longitudinal control information and the additional longitudinal control information, and may also execute processing for controlling the vehicle based on the final longitudinal control information in the traffic congestion situation.

In the present disclosure, the processor 122 is exemplified as being constituted by a single processing module for executing the above-described processing. As another example, the processor 122 may be constituted by a plurality of processing modules, and the processing may be distributed and performed in a plurality of modules.

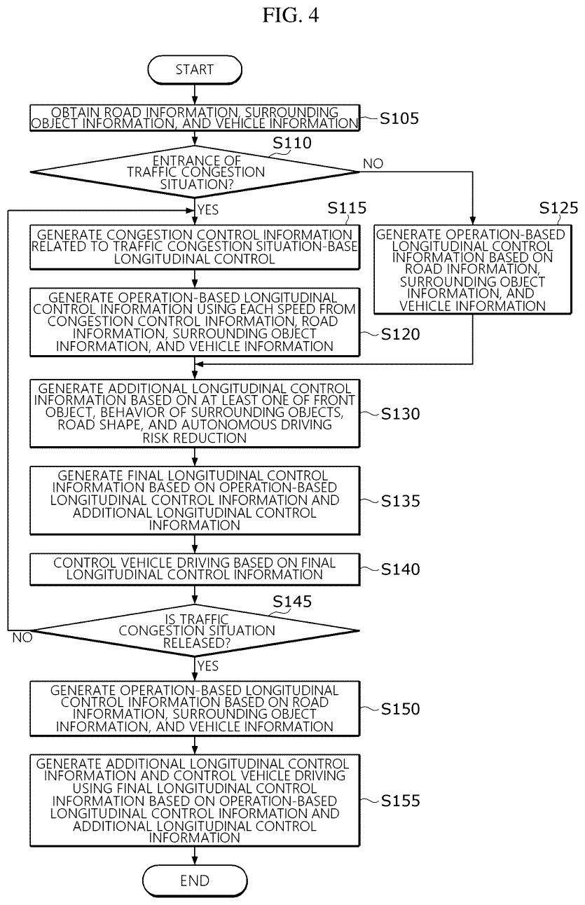

The aforementioned processing of the processor 122 will be described in detail with reference to FIGS. 4 to 7.

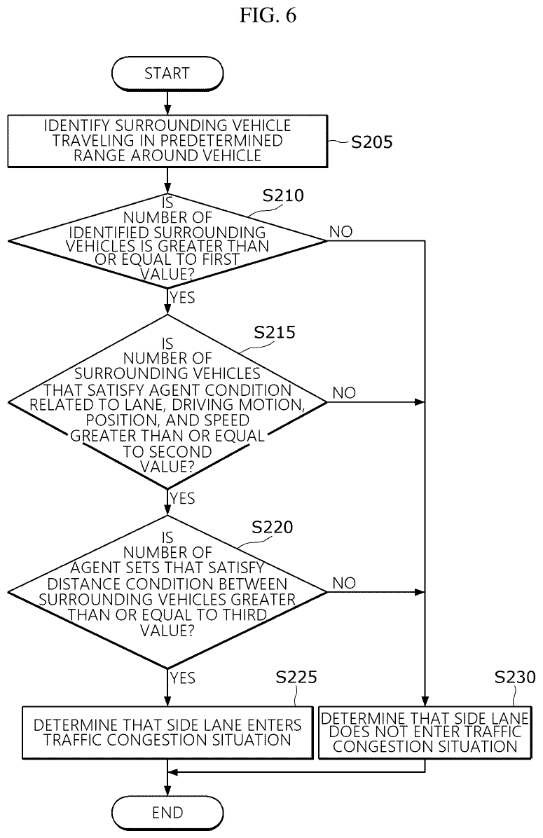

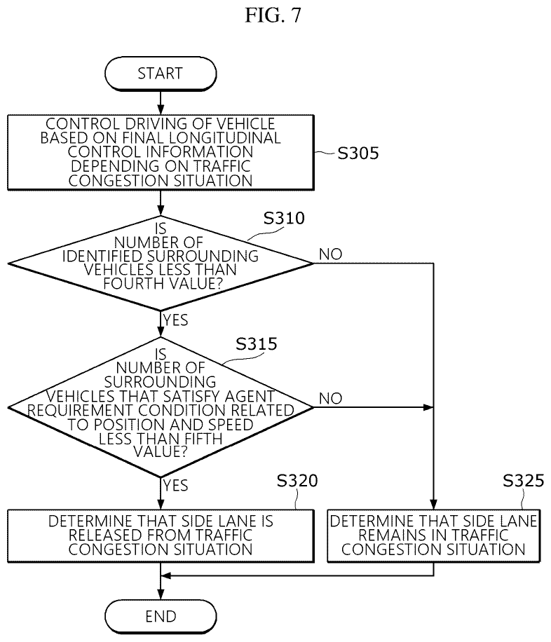

For convenience, FIG. 4, FIG. 6, and FIG. 7 are described by way of an example in which the steps are performed by a processor (e.g., control circuitry). One, some, or all steps of FIG. 4, FIG. 6, and FIG. 7, or portions thereof, may be performed by one or more other circuits. One or some, steps of FIG. 4, FIG. 6, and FIG. 7 may be omitted, performed in other orders, and/or otherwise modified, and/or one or more additional steps may be added.

FIG. 4 shows an example of a method of controlling a vehicle according to another example of the present disclosure.

The present disclosure mainly describes that the vehicle 100 autonomously moves, but may also be applied to an example of assisting manual driving. In addition, the processor 122 performing the method according to the present disclosure may be described interchangeably with the vehicle 100 for convenience of description.

First, the processor 122 of the vehicle 100 may obtain road information, surrounding object information, and vehicle information from the sensor unit 102 and an external device while the vehicle is moving in the autonomous driving (S105).

The road information may include at least lane level route information related to a driving lane EL of the vehicle and side lanes FL, FLM, RL, FR, and RR, road restriction information related to a speed limit of a road, and road event information related to a structure of the road and events in a driving area. Detailed information included in the road information may have the data described above in FIGS. 2 and 3.

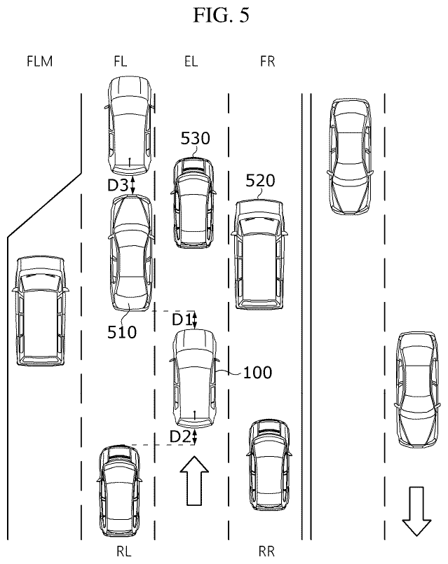

The driving lane of the vehicle 100 may be a lane corresponding to “EL” as shown in FIG. 5, and side lanes of surrounding vehicles 510 and 520 may be shown as left sight lanes FL, FLM, and RL and a right side lane FR and RR based on the driving lane EL. FIG. 5 shows an example of a form of a road on which a vehicle travels and surrounding vehicles.

In the present disclosure, each side lane may be subdivided into a front side lane FL, FLM, or FR and a rear side lane RL or RR based on the vehicle 100. The front side lane FL, FLM, or FR and the rear side lane RL or RR may be referred to interchangeably as a preceding side lane and a trailing side lane, respectively. Here, the preceding side lane may include a side lane arranged substantially parallel to the host vehicle 100.

In detail, the side lane FL may be referred to as the front left side lane or the preceding left side lane, and the side lane FLM may be referred to as the front left merging lane or the preceding left side merging lane. The side lane RL may be referred to as the front right side lane or the preceding right side lane. The side lane RL may be referred to as the rear left side lane or the trailing left side lane, and the side lane RR may be referred to as a rear right side lane or a trailing right side lane.

Although not shown in FIG. 5, the preceding side lane may further include a preceding right side merging lane or a front right merging lane (abbreviated as FRM) depending on the road shape. In addition, although not shown in FIG. 5, the trailing side lane may further include a trailing merging lane similar to the preceding merging lane FLM or FRM depending on the road shape. Specifically, the trailing side lane may be provided with a trailing left side merging lane (abbreviated as RLM) and/or a trailing right side merging lane (abbreviated as RRM).

The surrounding object information may have data related to the behavior of dynamic objects around the vehicle 100. The vehicle information may include data related to a longitudinal state of the vehicle 100, a sensing detection range of the surrounding environment of the vehicle 100, and autonomous driving control. Detailed information included in the surrounding object information and the vehicle information may have the data described above in FIGS. 2 and 3.

Next, the processor 122 may determine whether the driving area of the vehicle 100 enters a traffic congestion situation based on the road information in the side lanes FL, FLM, FR, RL, and RR around the driving lane EL of the vehicle 100, the surrounding object information in the side lanes FL, FLM, FR, RL, and RR, and the vehicle information (S110).

Specifically, based on the position of the vehicle 100, lane level route information, road restriction information, a longitudinal state of the vehicle 100, and the behavior of the surrounding vehicles 510 and 520 belonging to dynamic objects moving in the side lanes FL, FLM, RL, FR, and RR, the processor 122 may determine whether the side lanes FL, FLM, RL, FR, and RR are in the traffic congestion situation. When the side lanes FL, FLM, RL, FR, and RR are arranged as the left side lanes FL, FLM, and RL and the right side lane FR and RR on both sides of the driving lane EL as shown in FIG. 5, the determination of the traffic congestion situation may be separately processed for the left side lanes FL, FLM, and RL and the right side lane FR and RR.

Referring to FIG. 6, the determination of entry into a traffic congestion situation will be described in detail. FIG. 6 shows an example of a process of determining entry into a traffic congestion situation.

First, the vehicle 100 may recognize surrounding objects through data exchange with the sensor unit 102, surrounding vehicles, and other external devices, and the processor 122 may identify surrounding vehicles traveling in a predetermined range among surrounding objects using road information, surrounding object information, and vehicle information (S205).

The processor 122 may identify the driving lane EL based on sensor data acquired by, for example, the camera 104a and the lidar sensor 104b, the lane level route information, and the longitudinal state of the vehicle 100 (e.g., the position of the vehicle), as shown in FIG. 5. The processor 122 may identify surrounding vehicles 510 and 520 traveling in the same direction as the vehicle 100 within the predetermined range around the vehicle 100 based on the sensor data, the lane level route information, the positions of surrounding vehicles, the motion, or the like. The sensor data may be environmental recognition data including images and point cloud data obtained around the vehicle 100 by, for example, the camera 104a and the lidar sensor 104b. The predetermined range may be a spatial range in which there are surrounding vehicles that affect the driving of the vehicle 100. The predetermined range may be, for example, a side lane recognized from the sensor data, lane level route information, or the like. The predetermined range is not limited to the above-described matters, and may be set under various conditions, such as a range within a specific distance centered around the vehicle 100, a side lane within the specific distance, or the like. The range of the specific distance may be, for example, a radius-based circular range, a rectangular range defined by a longitudinal distance and a transverse distance, or the like. In the present disclosure, the description will focus on a case where the predetermined range is a side lane.

Accordingly, the processor 122 may identify the surrounding vehicles 510 and 520 moving in side lanes among surrounding objects, and generate or obtain surrounding object information related to the identified surrounding vehicles 510 and 520. According to FIG. 5, the side lanes FL, FLM, RL, FR, and RR may include general preceding side lanes FL and FR, a preceding merging lane FLM, and trailing side lanes RL and RR. Without being limited thereto, side lanes may have various types of lanes depending on the road structure. For example, the side lane may not include the preceding merging lane as shown in FIG. 5, or may further have at least one of the preceding left merging lane FRM, the trailing merging lanes RLM and RRM in addition or alternative to the type of side lanes shown in FIG. 5.

Next, the processor 122 may determine whether the number of surrounding vehicles 510 and 520 traveling in the side lanes FL, FLM, RL, FR, and RR is greater than or equal to a first value corresponding to an existence condition using the surrounding object information identified in the side lanes FL, FLM, RL, FR, and RR (S210).

The count of the surrounding vehicles 510 and 520 may be performed for each of the left side lanes FL, FLM, and RL and the right side lane FR and RR based on the driving lane EL. Regarding the count of the left side lanes, if there are surrounding vehicles in the preceding left side lane, that is, the general preceding left side lane or the preceding left side merging lane, the processor 122 may count the surrounding vehicle identified in the preceding left side lane. In addition, when there are more surrounding vehicles 510 and 520 in the trailing left side lane, that is, the general trailing left side lane or the trailing left side merging lane, in addition to the preceding left side lane, the processor 122 may count only a closest surrounding vehicle among the surrounding vehicles identified in the trailing left side lane, and may add the number of vehicles counted in the preceding left side lane and the number of vehicles counted in the trailing left side lane. The count in the right side lanes may be dealt with in the same way as the left side lanes described above. For another example, if there is only one of the left side lane or the right side lane, the count may only be performed on the existing side lane.

The first value related to the existence condition may be specified as plural, for example, two. The processor 122 may determine whether the number of surrounding vehicles 510 and 520 in each of the left side lanes FL, FLM, and the RL and the right side lane FR and RR is greater than or equal to the first value, and may determine whether the number of surrounding vehicles 510 and 520 is greater than or equal to the first value for each corresponding lane. As another example, if there is only one left side lane or right side lane, the processor 122 may determine whether the number of surrounding vehicles 510 and 520 in the existing side lanes is greater than or equal to the first value.

According to the example of FIG. 5, since both the left side lanes FL, FLM, and RL and the right side lane FR and RR exist, count of the surrounding vehicles 510 and 520 may be performed on side roads on both sides. In the case of the left side lanes FL, FLM, and RL, since the surrounding vehicles exist in the trailing left side lane RL, the processor 122 may count all surrounding vehicles 510 and 520 traveling in the preceding left side lane FL and the preceding left side merging lane FLM, and count the closest surrounding vehicle in the trailing left side lane RL. Then, the processor 122 may add up all of the counted numbers and determine whether the sum is greater than or equal to the first value. The count processing in the right side lane FR and RR may also be performed in the same manner as the above-described process in the left side lanes FL, FLM, and RL.

According to the example of FIG. 5, it is determined that the number of surrounding vehicles 510 and 520 in each of the left side lanes FL, FLM, and RL and the right side lane FR and RR exceeds the first value specified as two, and thus each of the left side lanes FL, FLM, and RL and the right side lane FR and RR) may be considered to satisfy the existence condition.

For convenience of description in operations S215 to S230 described below, operations S215 to S230 are mainly described in the left side lanes FL, FLM, and RL, but the operations S215 to S230 may be carried out in the right side lane FR and RR in a substantially similar manner.

If the number of surrounding vehicles 510 and 520 traveling in the side lanes FL, FLM, RL, FR, and RR is greater than or equal to the first value, the processor 122 may determine whether the number of surrounding vehicles 510 and 520 that satisfy an agent condition related to a driving motion, a position, a speed, and an occupied lane derived from surrounding object information about the surrounding vehicles 510 and 520 that satisfy the existence condition is greater than or equal to a second value (S215).

The surrounding vehicles 510 and 520 determining the satisfaction of the agent condition may be vehicles that satisfy the existence condition. If all of the above-described details related to the behavior of surrounding vehicles 510 and 520 are satisfied, the agent condition may be considered to be satisfied. The details of the surrounding vehicles 510 and 520, that is, the occupied lane, the driving motion, the position, and the speed, will be described below.

The occupied lanes may be lanes in which the surrounding vehicles 510 and 520 that satisfy the existence condition travel. The occupied lanes of the surrounding vehicles 510 and 520 that satisfy the agent condition may be left side lanes FL, FLM, RL and right side lanes FR, RR. Specifically, the condition related to occupied lanes may be satisfied when the surrounding vehicles 510 and 520 are in any one of the preceding left side lane FL, FLM, and RL, the trailing left side lanes FL, FLM, and RL, and the preceding left side merging lane FLM.

The driving motion may be divided into lane keeping driving and biased driving. The driving motion of the surrounding vehicle 510 that satisfy the agent condition may be defined as biased driving in the left side lanes FL and RL. In FIG. 5, it is shown that the surrounding vehicle 510 traveling in the preceding left side lane FL and a vehicle in front of the vehicle 510 behave in a motion according to the biased driving and other surrounding vehicles in the preceding and trailing left side lanes FL, FLM, and RL behave in the lane keeping driving. In the case of the right side road, it is shown that the surrounding vehicle 520 in the preceding right side lane FR behaves in the biased driving and other surrounding vehicles in the trailing right side lane RR move in the lane keeping driving.

The positions of the surrounding vehicles 510 and 520 that satisfy the agent condition may be determined by whether the positions fall within a specified distance range based on the vehicle 100. For all the surrounding vehicles 510 and 520 that satisfy the existence condition in the left side lane, the positions of the vehicles may be detected. The position detection may be performed, for example, through data exchange with the lidar sensor 104b, the radar sensor 104c, the surrounding vehicles 510 and 520, or an external device, or the like.

Considering that a traffic congestion situation in a future driving area of the vehicle 100 has a greater impact on the vehicle 100, the specified distance range may be set so that a section in front of the vehicle 100 has a longer distance than a section behind the vehicle 100 based on the vehicle 100. For example, the specified distance range may be set from a 50 m section in front of the vehicle 100 to 12.5 m behind the vehicle 100. The position of the surrounding vehicle 510 traveling in front of the vehicle 100 may be identified by a distance D1 between the vehicle 100 and the surrounding vehicle 510 for each surrounding vehicle as shown in FIG. 5, and the processor 122 may determine whether the distance D1 belongs to the section in front of the vehicle 100. In FIG. 5, the distance D1 is shown as a relative distance (or relative interval) between a front end of the vehicle 100 and a rear end of a surrounding vehicle 510, but points of the vehicle 100 and the surrounding vehicle 510 for measuring the distance D1 are not limited to the example described above and may be any portions. For example, a measurement point of the distance D1 may be the center of the rear wheels of each of the vehicle 100 and the surrounding vehicles 510, the center of the front wheels of each of the vehicles, or an arbitrary center point set by each of the vehicles 100 and 510. In addition, the position of a surrounding vehicle traveling behind the vehicle 100 is identified as a relative distance D2 to a surrounding vehicle closest to the vehicle, as shown in FIG. 5, and the processor 122 may determine whether the distance D2 belongs to the section in front of the vehicle 100. The distance D2 may also be measured in any one of the various ways of the distance D1.

The speeds of the surrounding vehicles 510 and 520 that satisfy the agent condition may be determined by whether the speeds fall within a specified speed range. For all surrounding vehicles 510 that satisfy the existence conditions in the left side lanes, the vehicle speeds may be detected. The speed detection may be implemented, for example, through data exchange with the lidar sensor 104b, the radar sensor 104c, the surrounding vehicles 510, 520, and 530, or an external device, or the like. The specified speed range may be defined, for example, as a longitudinal speed greater than or equal to 0 km and equal to or less than 30 km.

In summary, the processor 122 may analyze whether the aforementioned details of the agent condition are satisfied for each surrounding vehicle 510 in the left side lanes and identify the surrounding vehicles 510 that satisfy all the details. Then, the processor 122 may determine whether the number of identified surrounding vehicles 510 is greater than or equal to the second value. The second value may be specified as plural, for example, two.

The identification of surrounding vehicles that satisfy the agent condition in the right side lane FR and RR and comparison with the second value may also be performed in the same manner as the aforementioned process in the left side lanes FL, FLM, and RL.

If the number of surrounding vehicles that satisfy the agent condition in the left side lanes FL, FLM, and RL is greater than or equal to the second value, the processor 122 may determine whether the number of agent sets that satisfy the agent condition in the left side lanes FL, FLM, RL and satisfy a condition related to a relative distance D3 between adjacent surrounding vehicles 510 and surrounding vehicles in front of the vehicle 510 is greater than or equal to a third value (S220). The distance D3 may also be measured in any one of the various ways of the distance D1. For example, agent sets may be groups of agents, such as vehicles or dynamic objects, that meet specific conditions based on motion, position, speed, or proximity. These sets may be used to evaluate traffic conditions by identifying clusters of surrounding objects that exhibit certain behaviors, such as traveling closely together or within specific speed ranges. By analyzing these groups, it may determine whether the side lane is in a traffic congestion situation.

A distance condition satisfying the agent set may be experimentally set, and for example, may be within 20 m. The distance between the surrounding vehicles 510 and 520 may be detected through data exchange with, for example, the camera 104a, the lidar sensor 104b, the radar sensor 104c, the surrounding vehicles 510 and 520, or an external device, or the like. The third value may be specified as 1 or greater. The presence of the agent set in the right side lane FR and RR and comparison with the third value may also be performed in the same manner as the aforementioned process in the left side lanes FL, FLM, and RL.

If the number of agent sets is greater than or equal to the third value, the processor 122 may determine that the left side lane enters the traffic congestion situation (S225). Similarly, if the number of agent sets in the right side lane FR and RR is greater than or equal to the third value, the right side lanes may be considered as entering the traffic congestion situation.

Meanwhile, if the left side lane and the right side lane do not satisfy any of the conditions required in operations S210, S215, and S220 (NO in each of S210, S215, and S220), it may be determined that the corresponding side road does not enter the traffic congestion situation (S230).

Referring back to FIG. 4, if it is determined that at least one of the left side lanes FL, FLM, and RL and the right side lane FR and RR shown in FIG. 5 enters the traffic congestion situation, the processor 122 of the vehicle 100 may generate congestion control information related to longitudinal control of the vehicle 100 based on the road information and the surrounding object information (S115).

The road information may be, for example, speed limit information in configuration data. The speed limit information may be speed limit information required for the vehicle 100 in the driving area of the vehicle 100. The surrounding object information may be, for example, an average speed based on speeds and each speed of the surrounding vehicles related to the traffic congestion situation in the configuration data. The average speed of the corresponding side lane, estimated in the traffic congestion situation, may be referred to as a traffic congestion average speed.

In the present example, the congestion control information may be a traffic congestion target speed of the vehicle 100 in the traffic congestion situation during the longitudinal control. However, the congestion control information is not limited thereto and may further include an acceleration and a distance to surrounding vehicles. The target speed of the vehicle 100 according to the present example may be determined by the following.

First, as in the following Equation 1, a traffic congestion section speed may be determined based on a weighted sum of the speed limit of the vehicle 100 and the speeds of surrounding vehicles 510 and 520 traveling in the side lanes FL, FLM, RL, FR, and RR.

$${V}_{cngst} = {V}_{ego} {w}_{ego} + {V}_{left} {w}_{left} + {V}_{right} {w}_{right} \qquad [ Equation 1 ]$$

In Equation 1, V_{ego}, V_{left}, and V_{right} may be a speed limit of the vehicle 100, a left speed in the left side lane, and a right side speed on the right side road, respectively. If the side lane is in the traffic congestion situation, for the speed of the corresponding lane, an average traffic congestion speed may be used as an input value, and if the side lane does not enter the traffic congestion situation, for the speed of the corresponding lane, the speed limit of the side lane that does not enter the traffic congestion situation or the unentered side lane may be used as an input value.

V_{ego}, V_{left}, and V_{right} may be weights related to the vehicle 100, the left side speed, and the right side speed, respectively. When determining the weighted sum according to Equation 1, in order to further reflect the impact of the traffic congestion situation in the side lane, weights applied to the left and right average speeds may be set to be greater than the weight of the speed limit. Each weight may be experimentally determined, for example, V_{ego}, V_{left}, and V_{right} may be given as 0.2, 0.4, and 0.4, respectively.

In the example according to FIG. 5, if at least one of the left side lanes and the right side lanes is in the traffic congestion situation, since the side lane is determined as the traffic congestion situation in operation S110, at least one of the left speed and the right speed in Equation 1 may use the average traffic congestion speed of the corresponding lane. Unlike FIG. 5, if the side road exists only on one side of the driving lane EL and the side road is determined to be in the traffic congestion situation, only one of the left side speed and the right side speed may be used in Equation 1, and the corresponding speed may be input as the average traffic congestion speed of one side road.

When the traffic congestion section speed is determined according to Equation 1, the processor 122 may determine whether the traffic congestion section speed is greater than a minimum congestion control speed. The minimum traffic congestion control speed may be set, for example, according to traffic situations, regulations, or the like, of the road and driving area. If the traffic congestion section speed is greater than the minimum traffic congestion control speed, the processor 122 may determine the traffic congestion section speed as the traffic congestion target speed of the vehicle 100. In contrast, if the traffic congestion section speed is lower than the minimum traffic congestion control speed, the processor 122 may determine the minimum traffic congestion control speed as the traffic congestion target speed.

Next, the processor 122 of the vehicle 100 may generate operation-based longitudinal control information using each speed based on the congestion control information, the road information, the surrounding object information, and the vehicle information (S120).

The congestion control information may include a traffic congestion target speed, and the road information may include, in the configuration data, road restriction information in the driving lane EL or driving area and road event information on the road. The road restriction information may be, for example, a speed limit, and the road event information may include a construction zone, road event information, a slow-speed section due to bad weather, or the like. The surrounding object information may have a pedestrian recognition section estimated by recognizing the behavior of the surrounding pedestrian belonging to the dynamic object of the road in the configuration data. The vehicle information may include, for example, a sensing detection range of the sensor unit 102 that varies depending on the road shape, weather, or the like.

The processor 122 may obtain or generate an individual target speed based on each of the above-described items of information, and generate the operation-based longitudinal control information using a minimum individual target speed among the individual target speeds. Here, the longitudinal control information may include the speed and acceleration applied to the vehicle 100, and may be generated to have continuous velocity and acceleration profiles over a time range, for example. In addition or alternative, the operation-based longitudinal control information may use the minimum individual target speed as described above, but is not limited thereto, and may be output by various methods based on the items of information described above. In the present example, the longitudinal control information is described as the velocity and acceleration profiles, but as another example, may be a speed and an acceleration applied to any one of a distance range or a specific section on a route. As still another example, in addition or alternative to the speed and the acceleration, the longitudinal control information may further include control factors applied to the vehicle 100, for example, control according to a relative required distance to surrounding vehicles.

Meanwhile, if it is determined in operation S110 that neither the left side lane nor the right side lane enters the traffic congestion situation, the processor 122 may omit generation of the congestion control information and generate the operation-based longitudinal control information using each speed from the road information, the surrounding object information, and the vehicle information (S125). The longitudinal control information may be generated through a process substantially identical to operation S120, excluding the congestion control information.

When the operation-based longitudinal control information is generated in operation S120 or S125, the processor 122 may generate additional longitudinal control information based on at least one of a front object, a behavior of surrounding objects, a road shape, and autonomous driving risk reduction (S130).

To specifically describe the operation, the additional longitudinal control information may include at least one of front object-based longitudinal control information, surrounding state-based longitudinal control information including the behavior of surrounding objects and the road shape, and autonomous driving risk reduction-based longitudinal control information. The front object-based longitudinal control information may be generated based on the surrounding object information and the road information related to a front object traveling in the driving lane EL, such as the preceding vehicle 530, as shown in FIG. 5. The surrounding state-based longitudinal control information may be generated based on the surrounding object information including the driving motion (e.g., biased driving) of the surrounding vehicles traveling in the side lanes FL, FLM, RL, FR, and RR, and the road information related to the road structure (e.g., the road shape such as a curve, a front merge, or the like) and the road event information. The autonomous driving risk reduction-based longitudinal control information may be information defined in the action plan related to, a transfer action occurring in the vehicle 100, for example, control transfer from autonomous driving to manual driving. More specifically, the autonomous driving risk reduction-based longitudinal control information may be generated based on the vehicle information including the action plan of the vehicle corresponding to a user's non-operation in response to a request for the control transfer from autonomous driving to manual driving.

The additional longitudinal control information may be generated to have the velocity and acceleration profiles based on the data and information described above, similarly to the operation-based longitudinal control information. As another example, the additional longitudinal control information may have data in a format different from the example, and may be formed of data having the same format as the other example of the operation-based longitudinal control information mentioned in operation S120.

Next, the vehicle 100 may generate final longitudinal control information based on the operation-based longitudinal control information and the additional longitudinal control information (S135).

For example, the processor 122 may generate the final longitudinal control information based on an individual velocity/acceleration profile derived from each of the operation-based longitudinal control information, the front object-based longitudinal control information, the surrounding state-based longitudinal control information, and the autonomous driving risk reduction-based longitudinal control information. Here, the final longitudinal control information may be generated using a minimum profile among the individual profiles. The final longitudinal control information may use the minimum velocity/acceleration profile as described above, but is not limited thereto, and may be output by various methods based on the items of longitudinal control information described above.

Then, the processor 122 may control autonomous driving of the vehicle 100 in the driving area in the traffic congestion situation or a non-traffic congestion situation based on the velocity and acceleration profiles of the final longitudinal control information or the like (S140).

Meanwhile, the vehicle 100 may perform autonomous driving according to operation S140 in the traffic congestion situation determined in operation S110, thereby moving forward along the route. The traffic situation in the side lane around the forward-moving vehicle 100 may vary. That is, the traffic congestion situation in the side lane may be maintained or resolved depending on the traffic situation or the like.

Accordingly, after autonomous driving suitable for the traffic congestion situation is implemented, the processor 122 may determine whether the traffic congestion situation in the side lanes FL, FLM, RL, FR, and RR is released (S145).

Based on the road information, and the surrounding object information and the vehicle information identified in the side lanes FL, FLM, RL, FR, and RR, the processor 122 may determine whether the traffic congestion situation in the side lanes FL, FLM, RL, FR, and RR is released. The road information may be lane level route information in configuration data. The surrounding object information may include the behavior of the surrounding vehicles 510 and 520 belonging to dynamic objects moving in the side lanes FL, FLM, RL, FR, and RR. The vehicle information may include, for example, the position of the vehicle 100, the longitudinal state of the vehicle 100, and the like. When the side lanes FL, FLM, RL, FR, and RR are arranged as the left side lanes FL, FLM, and RL and the right side lane FR and RR on both sides of the driving lane EL as shown in FIG. 5, the determination of release of the traffic congestion situation by the processor 122 may be processed separately for the left side lanes FL, FLM, and RL and the right side lane FR and RR. Unlike in FIG. 5, when the side lane is only on one side of the driving lane EL, the release determination is described mainly in the left side lanes FL, FLM, and RL for convenience of description in operations in FIG. 7 that exist, which will be described below, but the operations may be carried out substantially identically in the right side lane FR and RR.

Referring to FIG. 7, a release determination of a traffic congestion situation will be described in detail. FIG. 7 shows an example of a process of determining release of a traffic congestion situation.

First, the processor 122 may control autonomous driving of the vehicle 100 based on the final longitudinal control information in the traffic congestion situation determined in operation S110, similarly to operation S140 (S305).

Next, the processor 122 may determine whether the number of surrounding vehicles 510 traveling in the left side lanes FL, FLM, and RL is less than a fourth value corresponding to a release condition using surrounding object information, road information, and vehicle information related to the surrounding vehicles 510 identified in the left side lanes FL, FLM, and RL existing within a predetermined range of the vehicle 100 (S310).

Pieces of information used to determine whether the number is less than the fourth value may each include the detailed data described above. The predetermined range may be, for example, a side lane recognized from sensor data, lane level route information, or the like. The predetermined range is not limited to the above-described matters and may be set to various conditions described in operation S205.

Regarding the count of surrounding vehicles 510, if there are surrounding vehicles 510 and 520 in the preceding left side lane, that is, the general preceding left side lane FL or the preceding left side merging lane FLM, the processor 122 may count the surrounding vehicle identified in the preceding left side lane. In addition, if there are more surrounding vehicles in the trailing left side lane, that is, the general trailing left side lane RL or the trailing left side merging lane, in addition to the preceding left side lane, the processor 122 may count only a closest surrounding vehicle among the surrounding vehicles identified in the trailing left side lane, and may add the number of vehicles counted in the preceding left side lane and the number of vehicles counted in the trailing left side lane.

The fourth value related to the release condition may be determined experimentally or according to traffic situations or the like. If there is a right side lane, the count for that lane and the comparison of the count with the fourth value may be handled in the same way as for the left side lanes described above.

If the number of surrounding vehicles 510 that satisfy the release condition is less than the fourth value, the processor 122 may determine whether the number of surrounding vehicles 510 that satisfy an agent requirement condition related to the position and speed derived from surrounding object information about surrounding vehicles 510 in the left side lanes FL, FLM, and RL that satisfy the release condition is less than a fifth value (S315).

The surrounding vehicle 510 determining the satisfaction of the agent requirement condition may be a vehicle that satisfies the release condition. If all of the above-described details related to the behavior of the surrounding vehicles 510 are satisfied, the agent requirement condition may be considered to be satisfied.

The position of the surrounding vehicle 510 that satisfies the agent requirement condition may be determined by whether the position falls within a specified distance range based on the vehicle 100, similarly to operation S215. For all the surrounding vehicles 510 that satisfy the release condition in the left side lane, the positions of the vehicles may be detected. The position detection may be performed, for example, through data exchange with the lidar sensor 104b, the radar sensor 104c, the surrounding vehicle 510 or an external device, or the like.

The specified distance range may be set so that the section in front of the vehicle 100 has a longer distance than the section behind the vehicle 100 based on the vehicle 100. For example, the specified distance range may be defined the same as the specified distance range in operation S215, and may be set as a section from a 50 m in front of the vehicle 100 to a 12.5 m behind the vehicle 100. The position of the surrounding vehicle 510 may be confirmed substantially in the same manner as described in operation S215.

The speed of the surrounding vehicle 510 that satisfies the agent requirement condition may be determined by whether the speed falls within a specified speed range. For all surrounding vehicles 510 that satisfy the existence conditions in the left side lanes, the vehicle speeds may be detected. In order to ensure definite release of the traffic congestion situation, the specified speed range may be defined as a wider section than the specified speed range in operation S215, for example, as a longitudinal speed greater than or equal to 0 km and equal to or less than 35 km.

In summary, the processor 122 may analyze whether the aforementioned details of the agent requirement condition are satisfied for each of the surrounding vehicles 510 and 520 in the left side lanes and identify the surrounding vehicles 510 that satisfy all the details. Then, the processor 122 may determine whether the number of identified surrounding vehicles 510 is less than the fifth value. The fifth value may be determined experimentally or based on traffic situations.

The identification of surrounding vehicles that satisfy the agent requirement condition in the right side lane FR and RR and comparison with the fifth value may also be performed in the same manner as the aforementioned process in the left side lanes FL, FLM, and RL.

If the number of surrounding vehicles 510 in the left side lanes FL, FLM, and RL that satisfy the agent requirement condition is less than the fifth value, the processor 122 may determine that the left side lanes are released from the traffic congestion situation (S320). Similarly, if there are less than five surrounding vehicles that satisfy the agent requirement condition in the right side lane FR and RR, the right side lane may be considered to be released from the traffic congestion situation.

Meanwhile, if the left side and right side roads do not satisfy any of the conditions required in operations S310 and S315 (NO in each of S310 and S315), it is determined that the traffic congestion situation on the corresponding side road remains (S325).

Referring back to FIG. 4, if it is determined that the traffic congestion situation is released in all of the left side lanes FL, FLM, and RL and the right side lane FR and RR shown in FIG. 5, the processor 122 of the vehicle 100 may generate operation-based longitudinal control information based on the road information, the surrounding object information, and the vehicle information (S150). The longitudinal control information may be formed in the same manner as operation S125 (that is, in the manner in operation S120 where the congestion control information is omitted).

Next, the processor 122 may generate additional longitudinal control information based on at least one of the behavior of the front object, the surrounding objects, the road shape, and autonomous driving risk reduction, substantially the same as operation S130. Then, the vehicle 100 may generate final longitudinal control information based on the operation-based longitudinal control information and the additional longitudinal control information, substantially the same as operations S135 and S140, and control autonomous driving of the vehicle 100 in the driving area where the traffic congestion situation has been released (S155).

If it is determined that at least one of the left side lanes FL, FLM, and RL and the right side lane FR and RR remains in the traffic congestion situation in operation S145, the processor 122 may execute related processing from operation S115.

According to the present disclosure, there is provided a method of controlling an autonomous vehicle. The method comprising: determining whether a side lane surrounding a driving lane of a vehicle is in a traffic congestion situation based on road information in the side lane, surrounding object information in the side lane, and vehicle information; generating congestion control information related to longitudinal control of the vehicle based on the road information and the surrounding object information in response to the traffic congestion situation; generating operation-based longitudinal control information using each speed from the congestion control information, the road information, the surrounding object information, and the vehicle information; and controlling the vehicle in the traffic congestion situation based on at least the operation-based longitudinal control information.

According to the example of the present disclosure in the method, the road information may include at least lane level route information related to the driving lane of the vehicle and the side lane, road restriction information related to a speed limit of the road, a structure of the road, and road event information related to an event in a driving area. The surrounding object information may include data related to a behavior of a dynamic object around the vehicle, and the vehicle information includes a longitudinal state of the vehicle, a sensing detection range of a surrounding environment of the vehicle, and data related to autonomous driving control.

According to the example of the present disclosure in the method, the determining of whether the side lane may be in the traffic congestion situation includes determining whether the side lane is in the traffic congestion situation based on the lane level route information, the road restriction information, the longitudinal state of the vehicle, and a behavior of a surrounding vehicle belonging to the dynamic object moving in the side lane.

According to the example of the present disclosure in the method, the generating of the operation-based longitudinal control information may include: providing individual target speeds based on each of the road restriction information, the road event information, the sensing detection range of the vehicle, a behavior of a surrounding pedestrian belonging to the dynamic object, and the congestion control information; and generating the operation-based longitudinal control information based on a minimum individual target speed among the individual target speeds.

According to the example of the present disclosure in the method, the determining of whether the side lane is in the traffic congestion situation may include: determining whether the number of surrounding vehicles traveling in the side lane is greater than or equal to a first value corresponding to an existence condition using the surrounding object information identified in the side lane existing within a predetermined range of the vehicle; in response to the number being greater than or equal to the first value, determining whether the number of surrounding vehicles that satisfy an agent condition related to a driving motion, a position, and a speed derived from surrounding object information about the surrounding vehicles that satisfy the existence condition is greater than or equal to a second value; in response to the number being greater than or equal to the second value, determining whether the number of agent sets that satisfy the agent condition and satisfy a distance condition of the adjacent surrounding vehicles is greater than or equal to a third value; and in response to the number being greater than or equal to the third value, determining that the side lane is in the traffic congestion situation.

According to the example of the present disclosure in the method, the method may further comprise: after the controlling of the vehicle in the traffic congestion situation, determining whether the number of surrounding vehicles traveling in the side lane is less than a fourth value corresponding to a release condition using the surrounding object information identified in the side lane existing within a predetermined range of the vehicle; in response to the number being less than the fourth value, determining whether the number of surrounding vehicles that satisfy an agent requirement condition related to a position and speed derived from surrounding object information about the surrounding vehicles that satisfy the release condition is less than a fifth value; in response to the number being less than the fifth value, determining release of the traffic congestion situation; and in addition to the generating of the operation-based longitudinal control information using the each speed from the road information, the surrounding object information, and the vehicle information, controlling the vehicle in a driving area of the vehicle based on at least the operation-based longitudinal control information.

According to the example of the present disclosure in the method, the method may further comprise: prior to the controlling of the vehicle in the traffic congestion situation, generating additional longitudinal control information including at least one of longitudinal control information based on a front object traveling in the driving lane, surrounding state-based longitudinal control information according to a driving motion of a surrounding vehicle traveling in the side lane and a road shape, and autonomous driving risk reduction-based longitudinal control information defined in an action plan related to control transfer from autonomous driving to manual driving; and generating final longitudinal control information based on the operation-based longitudinal control information and the additional longitudinal control information. The controlling of the vehicle in the traffic congestion situation may include controlling the vehicle based on the final longitudinal control information.

According to the example of the present disclosure in the method, the generating of the congestion control information may include: determining a traffic congestion section speed based on a weighted sum of a speed limit required for the vehicle in a driving area of the vehicle and an average traffic congestion speed of surrounding vehicles traveling in the side lane; and determining the traffic congestion section speed as a traffic congestion target speed of the vehicle if the traffic congestion section speed is greater than a minimum traffic congestion control speed and determining the minimum traffic congestion control speed as the traffic congestion target speed if the traffic congestion section speed is equal to or lower than the minimum traffic congestion control speed.

According to the example of the present disclosure in the method, for the weighted sum, a weight applied to the average traffic congestion speed may be set to be greater than a weight of the speed limit.

According to the example of the present disclosure in the method, the method may further comprise: in response to non-occurrence of the traffic congestion situation, generating the operation-based longitudinal control information using the each speed from the road information, the surrounding object information, and the vehicle information; and controlling the vehicle in a driving area of the vehicle based on at least the operation-based longitudinal control information.

According to another example of the present disclosure, there is provided a vehicle that is based on autonomous driving, the vehicle comprising: a sensor unit configured to detect a surrounding environment of the vehicle; a memory configured to store at least one instruction for controlling the vehicle; and a processor configured to execute the at least one instruction stored in the memory. The processor is configured to: determine whether a side lane surrounding a driving lane of the vehicle is in a traffic congestion situation based on road information in the side lane, surrounding object information in the side lane, and vehicle information; generate congestion control information related to longitudinal control of the vehicle based on the road information and the surrounding object information in response to the traffic congestion situation; generate operation-based longitudinal control information using each speed from the congestion control information, the road information, the surrounding object information, and the vehicle information; and control the vehicle in the traffic congestion situation based on at least the operation-based longitudinal control information.

According to the present disclosure, it is possible to provide a method of controlling an autonomous vehicle that improves driving performance by supporting an autonomous driving plan specialized for traffic congestion situations, thereby preventing discomfort caused to a user and a vehicle.

The effects obtainable from the present disclosure are not limited to the effects mentioned above, and other effects not mentioned may be clearly understood by those of ordinary skill in the art to which the present disclosure belongs from the following description.

While the exemplary methods of the present disclosure described above are represented as a series of operations for clarity of description, it is not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some of the steps.

The various examples of the present disclosure are not a list of all possible combinations and are intended to describe representative examples of the present disclosure, and the matters described in the various examples may be applied independently or in combination of two or more.

In addition, various examples of the present disclosure may be implemented in hardware, firmware, software, or a combination thereof. In the case of implementing the present disclosure by hardware, the present disclosure may be implemented with application specific integrated circuits (ASICs), Digital signal processors (DSPs), digital signal processing devices (DSPDs), programmable logic devices (PLDs), field programmable gate arrays (FPGAs), general processors, controllers, microcontrollers, microprocessors, etc.

The scope of the disclosure includes software or machine-executable commands (e.g., an operating system, an application, firmware, a program, etc.) for enabling operations according to the methods of various examples to be executed on an apparatus or a computer, a non-transitory computer-readable medium having such software or commands stored thereon and executable on the apparatus or the computer.

What is claimed is:

1. A method performed by an apparatus for controlling autonomous driving of a vehicle, the method comprising:
determining whether a side lane is in a traffic congestion situation based on road information associated with the side lane, object information associated with the side lane, and vehicle information associated with the vehicle, wherein the side lane is within a threshold distance from a driving lane of the vehicle;
generating congestion control information based on the road information, the object information, and a determination that the side lane is in the traffic congestion situation, wherein the congestion control information is related to a longitudinal control of the vehicle;
generating operation-based longitudinal control information based on a plurality of speeds, wherein each speed of the plurality of speeds is respectively derived from the congestion control information, the road information, the object information, and the vehicle information; and
controlling, based on at least the operation-based longitudinal control information, autonomous driving of the vehicle.

2. The method of claim 1, wherein the road information comprises:
lane level route information related to the driving lane of the vehicle and the side lane,
road restriction information related to a speed limit of a road,
road structure information related to a structure of the road, and
road event information related to an event in a driving area,
wherein the object information comprises data related to a behavior of a dynamic object within a threshold spatial range of the vehicle,
and wherein the vehicle information comprises:
a longitudinal state of the vehicle,
a sensor detection range of an environment associated with the vehicle, and
data related to autonomous driving control.

3. The method of claim 2, wherein the determining whether the side lane is in the traffic congestion situation comprises determining whether the side lane is in the traffic congestion situation based on the lane level route information, the road restriction information, the longitudinal state of the vehicle, and the behavior of the dynamic object, wherein the dynamic object comprises another vehicle moving in the side lane.

4. The method of claim 2, wherein the generating the operation-based longitudinal control information comprises:
identifying a plurality of individual target speeds, wherein each individual target speed of the plurality of individual target speeds is respectively derived from the road restriction information, the road event information, the sensor detection range of the vehicle, the behavior of the dynamic object, and the congestion control information, wherein the dynamic object comprises a pedestrian; and
generating, based on a minimum individual target speed among the plurality of individual target speeds, the operation-based longitudinal control information.

5. The method of claim 1, wherein the determining whether the side lane is in the traffic congestion situation comprises:
determining whether a number of identified vehicles traveling in the side lane, identified based on the object information, is greater than or equal to a first value corresponding to an existence condition, wherein the side lane is within a predetermined range of the vehicle;
based on the number of identified vehicles traveling in the side lane being greater than or equal to the first value, determining whether a number of identified vehicles that satisfy an agent condition is greater than or equal to a second value, wherein the agent condition is related to a driving motion, a position, and a speed derived from the object information, and wherein the objection information comprises information about identified vehicles that satisfy the existence condition;
based on the number of identified vehicles that satisfy the agent condition being greater than or equal to the second value, determining whether a number of agent sets that satisfy both the agent condition and a distance condition of the identified vehicles is greater than or equal to a third value; and
based on the number of the agent sets being greater than or equal to the third value, determining that the side lane is in the traffic congestion situation.

6. The method of claim 1, further comprising, after the controlling the autonomous driving of the vehicle:
determining whether a number of identified vehicles traveling in the side lane, identified based on the object information, is less than a fourth value corresponding to a release condition, wherein the side lane is within a predetermined range of the vehicle;
based on the number of identified vehicles traveling in the side lane being less than the fourth value, determining whether a number of identified vehicles that satisfy an agent requirement condition is less than a fifth value, wherein the agent requirement condition is related to a position and speed derived from the object information, and wherein the object information comprises information about identified vehicles that satisfy the release condition; and
based on the number of identified vehicles that satisfy the agent requirement condition being less than the fifth value, determining a release of the traffic congestion situation.

7. The method of claim 1, further comprising, before the controlling the autonomous driving of the vehicle:
generating additional longitudinal control information, wherein the additional longitudinal control information comprises at least one of:
longitudinal control information based on a front object traveling in the driving lane,
surrounding state-based longitudinal control information according to a driving motion of an identified vehicle traveling in the side lane and a road shape, and
autonomous driving risk reduction-based longitudinal control information defined in an action plan related to control transfer from autonomous driving to manual driving; and
generating, based on the operation-based longitudinal control information and the additional longitudinal control information, final longitudinal control information,
wherein the controlling the autonomous driving of the vehicle comprises controlling, based on the final longitudinal control information, the autonomous driving of the vehicle.

8. The method of claim 1, wherein the generating the congestion control information comprises:
determining a traffic congestion section speed, wherein the traffic congestion section speed is determined based on a weighted sum of:
a speed limit required for the vehicle in the driving lane, and
an average traffic congestion speed of identified vehicles traveling in the side lane;
determining the traffic congestion section speed as a traffic congestion target speed based on the traffic congestion section speed being greater than a minimum traffic congestion control speed; and
determining the minimum traffic congestion control speed as the traffic congestion target speed based on the traffic congestion section speed being equal to or lower than the minimum traffic congestion control speed.

9. The method of claim 8, wherein the weighted sum comprises:
a first weight applied to the average traffic congestion speed; and
a second weight applied to the speed limit, and wherein the first weight is greater than the second weight.

10. The method of claim 1, further comprising:
based on absence of the traffic congestion situation, generating second operation-based longitudinal control information based on a plurality of speeds, wherein each speed of the plurality of speeds is respectively derived from the road information, the object information, and the vehicle information; and
controlling, based on at least the second operation-based longitudinal control information, the autonomous driving of the vehicle.

11. An apparatus for controlling autonomous driving of a vehicle, the apparatus comprising:
a sensor configured to detect an environment within a threshold range of the vehicle;
a processor configured to execute at least one instruction; and
a memory configured to store the at least one instruction that, when executed by the processor, is configured to cause the apparatus to:
determine whether a side lane is in a traffic congestion situation based on road information associated with the side lane, object information associated with the side lane, and vehicle information associated with the vehicle, wherein the side lane is within a threshold distance from a driving lane of the vehicle;
generate congestion control information based on the road information, the object information, and a determination that the side lane is in the traffic congestion situation, wherein the congestion control information is related to a longitudinal control of the vehicle;
generate operation-based longitudinal control information based on a plurality of speeds, wherein each speed of the plurality of speeds is respectively derived from the congestion control information, the road information, the object information, and the vehicle information; and
control, based on at least the operation-based longitudinal control information, autonomous driving of the vehicle.

12. The apparatus of claim 11, wherein the road information comprises:
lane level route information related to the driving lane of the vehicle and the side lane,
road restriction information related to a speed limit of a road,
road structure information related to a structure of the road, and
road event information related to an event in a driving area,
wherein the object information comprises data related to a behavior of a dynamic object within a threshold spatial range of the vehicle,
and wherein the vehicle information comprises:
a longitudinal state of the vehicle,
a sensor detection range of the sensor, and
data related to autonomous driving control.

13. The apparatus of claim 12, wherein the at least one instruction, when executed by the processor, is configured to cause the apparatus to determine whether the side lane is in the traffic congestion situation by determining whether the side lane is in the traffic congestion situation based on the lane level route information, the road restriction information, the longitudinal state of the vehicle, and the behavior of the dynamic object, wherein the dynamic object comprises another vehicle moving in the side lane.

14. The apparatus of claim 12, wherein the at least one instruction, when executed by the processor, is configured to cause the apparatus to generate the operation-based longitudinal control information by:
identifying a plurality of individual target speeds, wherein each individual target speed of the plurality of individual target speeds is respectively derived from the road restriction information, the road event information, the sensor detection range of the sensor, the behavior of the dynamic object, and the congestion control information, wherein the dynamic object comprises a pedestrian; and
generating, based on a minimum individual target speed among the plurality of individual target speeds, the operation-based longitudinal control information.

15. The apparatus of claim 11, wherein the at least one instruction, when executed by the processor, is configured to cause the apparatus to determine whether the side lane is in the traffic congestion situation by:
determining whether a number of identified vehicles traveling in the side lane, identified based on the object information, is greater than or equal to a first value corresponding to an existence condition, wherein the side lane is within a predetermined range of the vehicle;
based on the number of identified vehicles traveling in the side lane being greater than or equal to the first value, determining whether a number of identified vehicles that satisfy an agent condition is greater than or equal to a second value, wherein the agent condition is related to a driving motion, a position and a speed derived from the object information, and wherein the object information comprises information about surrounding vehicles that satisfy the existence condition;
based on the number of identified vehicles that satisfy the agent condition being greater than or equal to the second value, determining whether a number of agent sets that satisfy both the agent condition and a distance condition of the identified vehicles is greater than or equal to a third value; and
based on the number of the agent sets being greater than or equal to the third value, determining that the side lane is in the traffic congestion situation.

16. The apparatus of claim 11, wherein after controlling the autonomous driving of the vehicle, the at least one instruction, when executed by the processor, is further configured to cause the apparatus to:
determine whether a number of identified vehicles traveling in the side lane, identified based on the object information, is less than a fourth value corresponding to a release condition, wherein the side lane is within a predetermined range of the vehicle;
based on the number of identified vehicles traveling in the side lane being less than the fourth value, determine whether a number of identified vehicles that satisfy an agent requirement condition is less than a fifth value, wherein the agent requirement condition is related to a position and speed derived from the object information, and wherein the object information comprises information about identified vehicles that satisfy the release condition; and
based on the number of identified vehicles that satisfy the agent requirement condition being less than the fifth value, determine a release of the traffic congestion situation.

17. The apparatus of claim 11, wherein before the controlling the autonomous driving of the vehicle, the at least one instruction, when executed by the processor, is further configured to cause the apparatus to:
generate additional longitudinal control information, wherein the additional longitudinal control information comprises at least one of:
longitudinal control information based on a front object traveling in the driving lane,
surrounding state-based longitudinal control information according to a driving motion of an identified vehicle traveling in the side lane and a road shape, and
autonomous driving risk reduction-based longitudinal control information defined in an action plan related to control transfer from autonomous driving to manual driving;
generate, based on the operation-based longitudinal control information and the additional longitudinal control information, final longitudinal control information; and
control the autonomous driving of the vehicle by controlling, based on the final longitudinal control information, the autonomous driving of the vehicle.

18. The apparatus of claim 11, wherein at least one instruction, when executed by the processor, is configured to cause the apparatus to generate the congestion control information by:
determining a traffic congestion section speed, wherein the traffic congestion section speed is determined based on a weighted sum of:
a speed limit required for the vehicle in the driving lane of the vehicle, and
an average traffic congestion speed of identified vehicles traveling in the side lane;
determining the traffic congestion section speed as a traffic congestion target speed based on the traffic congestion section speed being greater than a minimum traffic congestion control speed; and
determining the minimum traffic congestion control speed as the traffic congestion target speed based on the traffic congestion section speed being equal to or lower than the minimum traffic congestion control speed.

19. The apparatus of claim 18, wherein the weighted sum comprises:
a first weight applied to the average traffic congestion speed; and
a second weight applied to the speed limit, and wherein the first weight is greater than the second weight.

20. The apparatus of claim 11, wherein the at least one instruction, when executed by the processor, is further configured to cause the apparatus to:
based on absence of the traffic congestion situation, generate second operation-based longitudinal control information based on a plurality of speeds, wherein each speed of the plurality of speeds is respectively derived from the road information, the object information, and the vehicle information; and
control, based on at least the second operation-based longitudinal control information, the autonomous driving of the vehicle.
